(19) United States
(12) Patent Application Publication
(10) Pub. No.: US 2025/0156456 A1
(43) Pub. Date: May 15, 2025

(54) LARGE LANGUAGE MODEL ADAPTATION FOR GROUNDING

(71) Applicant: Google LLC, Mountain View, CA (US)

(72) Inventors: Ruoxi Sun, Mountain View, CA (US); Xi Ye, New York, NY (US); Sercan Omer Arik, San Francisco, CA (US)

(21) Appl. No.: 18/947,752

(22) Filed: Nov. 14, 2024

Related U.S. Application Data
(60) Provisional application No. 63/599,475, filed on Nov. 15, 2023.

(51) Int. Cl. G06F 16/332; G06F 40/30

(52) U.S. Cl. CPC G06F 16/3329; G06F 16/3326; G06F 40/30

(57) ABSTRACT

Methods, systems, and apparatus, including computer programs encoded on a computer storage medium, for grounding LLMs. In one aspect, a method includes accessing responses from a large language model, each response comprising data including: a query, an answer to the query, the answer comprising one or more statements, citations linking each statement to an evidence passage in a corpus; determining a grounding quality of the answer based on the evidence passages and the statements using an attribution evaluation model, wherein the grounding quality is a quantification of attribution of the statements in the answer to a document corpus; and tuning the large language model to obtain an adapted large language model that satisfies a grounding constraint based on grounding quality score.

### CROSS-REFERENCE TO RELATED APPLICATION

This application claims the benefit under 35 U.S.C. § 119(e) of priority to U.S. Provisional Application No. 63/599,475, filed on Nov. 15, 2023, which is incorporated by reference in its entirety into the disclosure of this application.

### BACKGROUND

Large language models (LLMs) have achieved remarkable advancements in natural language understanding, generation, and manipulation of text-based data. The ability of an LLM to understand, generate, and manipulate text at unprecedented scales and depths has established them as a transformative force within the field of artificial intelligence. Despite their widespread adoption, however, one prominent issue of LLMs is that in certain scenarios LLMs hallucinate, i.e., they generate plausible sounding but nonfactual information. Hallucination limits the applicability of LLMs in real-world settings.

To mitigate hallucinations, solutions generally rely on grounding the claims in LLM-generated responses to supported passages by providing an attribution report or adding citations to the claims. Some processes use instruction tuning or in-context learning to instruct LLMs to generate grounded responses with citations to retrieved passages, following the retrieval-augmented generation framework. As LLMs are required to perform this challenging task from just instructions and few-shot demonstrations, such directions often lead to unsatisfactory grounding quality. Other processes use post-hoc citing, which links support passages to the claims in responses using a natural language inference (NLI) model. This paradigm heavily relies on LLMs' parametric knowledge and does not extend well to more specific and narrow knowledge fields.

### SUMMARY

This specification describes systems and methods for grounding an LLM. During training, a system collects data and uses the collected data for tuning an LLM to self-ground, e.g., attributing its responses to passages, and self-evaluate, e.g., assessing the reliability of the answer, to improve both grounding quality and selective prediction performance. Then an iterative inference process allows the adapted LLM to seek for additional information based on the self-grounding evaluation to refine results.

In an implementation, a computer-implemented method comprises accessing responses from a large language model, each response comprising data including: a query Q, an answer A to the query, the answer comprising one or more statements s, citations C linking each statement to an evidence passage E in a corpus D; determining a grounding quality G of the answer based on the evidence passages and the statements using an attribution evaluation model, wherein the grounding quality is a quantification of attribution of the statements in the answer to a document corpus; and tuning the large language model to obtain an adapted large language model that satisfies a grounding constraint based on grounding quality score.

An addition aspect further comprises iteratively processing a query by the adapted large language model, comprising: initially processing the query by the adapted large language model to obtain an answer for the query and citations for passages in the answer; for each subsequent iteration: determining which passages in the answer are not supported by a citation, adding the passages that are supported by a citation to a list of relevant passages, and if there are one or more passage in the answer that are not supported by a citation, then, for each passage not supported, processing the passage not supported to generate a subsequent answer and citations for passages in the subsequent answer, and otherwise processing the query by the adapted large language model to obtain a subsequent answer for the query and citations for passages in the subsequent answer.

In an additional aspect, iteratively processing the query by the adapted large language model to obtain an answer for the query and citations for passages in the answer comprises iteratively processing the query by the adapted large language model until an inference budget is exhausted.

In an additional aspect, determining a grounding quality G of the answer based on the evidence passages and the statements using an attribution evaluation model comprises determining a sum of attribution evaluation model outputs, each output based on an evidence passage and statement provided as input to the attribution evaluation model.

In an additional aspect, tuning the large language model to obtain an adapted large language model that satisfies a grounding constraint based on grounding quality score further comprises tuning the large language model so that answers generated by the adapted large language model maximizing scores with the respect to the large language model.

Another implementation includes a system comprising one or more computers and one or more storage devices storing instructions that are operable, when executed by the one or more computers, to cause the one or more computers to perform the operations of the respective method described above.

Particular embodiments of the subject matter described in this specification can be implemented so as to realize one or more of the following advantages. The systems and methods herein adapt an LLM to generate its own citations, which reduces the overhead that would otherwise be required when invoking a post-hoc model, such as a Natural Language Inference (NLI) model to generate citations for responses generated by a base LLM. The training can be done without need of samples from a target domain, which reduces preparation overhead. Hallucination is also reduced due to the adapted LLM's ability to generate citations for supported statements.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a system flow diagram of a training process that tunes a base LLM into an adapted LLM able to self-ground its response.

FIG. 1B is an example of tuning training data generated during the turning process of FIG. 1A.

FIG. 2 is a flow diagram of an example process for tuning an LLM into an adapted LLM.

FIG. 3A is a system flow diagram of a retrieval augmented generation process that the adapted LLM uses to self-ground its response to add citations to supported passages and identify unsupported passages.

FIG. 3B is an illustration of an example inference procedure performed in the system flow of FIG. 3A.

FIG. 4 is a flow diagram of an example process of self-grounding the adapted LLM response to add citations to supported passages and identify unsupported passages.

Like reference numbers and designations in the various drawings indicate like elements.

### DETAILED DESCRIPTION

This written description describes a Large Language Model (LLM) adaptation for grounding enhancement that tunes an LLM to self-ground the claims in its responses and provide accurate citations to retrieved documents. This tuning on top of the pre-trained base LLM requires well-grounded responses with citations for paired queries. The method automatically constructs such data from unlabeled queries. The self-grounding capability of adapted LLM further provides a test-time adaptation (TTA) capability that can actively retrieve passages to support the claims that have not been grounded, which iteratively improves the responses of adapted LLM.

In operation, the adaptation system adapts an LLM to generate citations, which obviates the need for prompting or relying on an external NLI model or other model for post-hoc citation generation. First, during a training phase, the adaptation system collects well-grounded responses for unlabeled queries automatically from a base LLM. In some implementations, an NLI model is used to generate the citations for training. The training data of queries, passages and responses with citations are generated. Next, the collected data (queries, responses generated by the LLM, and the citations generated from the responses) are used for supervising the LLM to generate grounded responses based on the retrieved passages as well as to include citations in the responses.

During an iterative inference phase, the adaptation system uses an iterative inference process that allows the adapted LLM to seek for additional information based on the self-grounding evaluation so as to refine its response. The tuning and iterative inference process together enable adaptation of a base LLM into an adapted LLM that effectively and efficiently grounds responses by citations to a corpus.

In summary, a training process adapts a base LLM that generates responses into an adapted LLM that includes accurate citations in its response, leveraging automatically created data. The iterative inference process improves responses of LLM based on the citation information.

These features and additional features are described in more detail below.

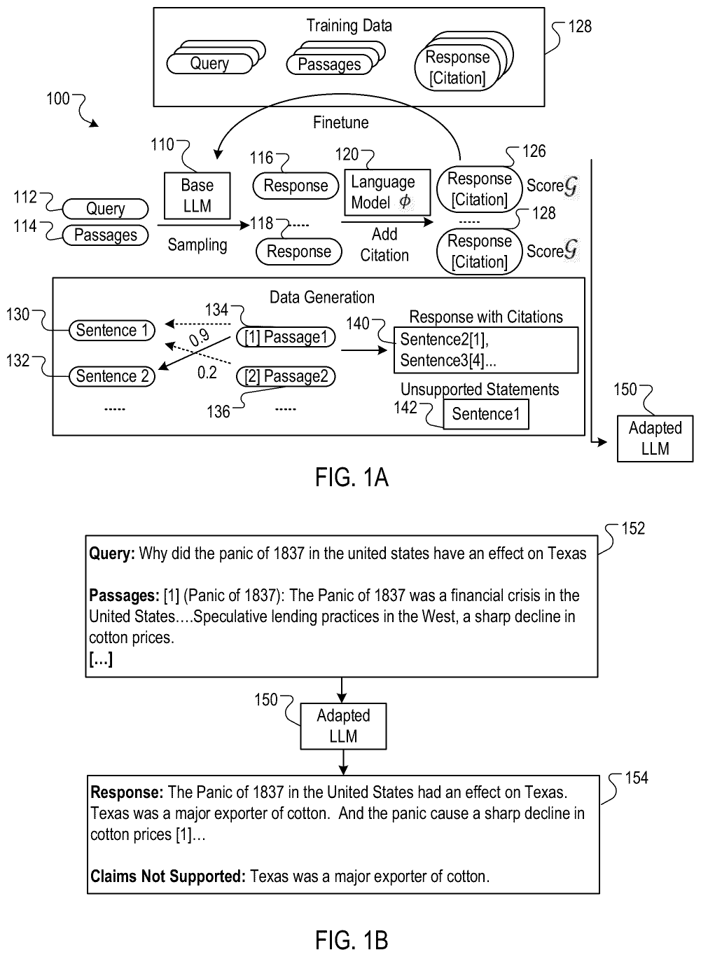

FIG. 1A is a system flow diagram 100 of a training process that tunes a base LLM 110 into an adapted LLM 150 able to self-ground its response. The system adapts a pretrained base LLM 110 [symbol] to the adapted LLM 150 [symbol] that is able to provide grounded responses with citations. Given a text query 112 Q and a corpus [symbol] ={dᵢ} of text passages 114, the adapted LLM 150 [symbol] generates responses A to the query 112 that is factually grounded in the corpus [symbol] as well as providing citations [symbol] together with its response.

To generate training data, in some implementations, the base LLM 110 outputs responses 116, 118, and another model, model 120, adds citations. The responses are segmented into statements, e.g., sentences, and each statement is cited to one or more passages from the corpus. Specifically, let s₁, . . . , Sₙ be the statements in the answer A=s₁, . . . , sₙ. The citations [symbol] ={E₁, . . . , Eₙ} link each statement sᵢ to a set of evidence passages Eᵢ⊂ [symbol] .

The adaptation of the LLM enables the adapted LLM 150 to provide grounded responses. With citations [symbol] , the system quantifies the grounding quality of a response A by a grounding score [symbol] :

$$𝒢 ( A , 𝒞 ) = \frac{1}{n} {\sum }_{i} ϕ ( concat ( {E}_{i} ) , {s}_{i} ) ,$$

where ϕ represents the language model 120 that assesses whether the concatenated passage concat(Eᵢ) supports sᵢ. In some implementations, the grounding score [symbol] essentially averages how well each sentence is supported by its citations.

In some implementations, to tune an adapted LLM 150, the system tunes the base LLM 110 to self-ground the claims in responses. The grounding is done by generating citations to sources in the corpus that support the responses in the answer. The system trains the LLM 110 into the adapted LLM 150 using a collection of unlabeled queries {Q} and the language model ϕ 120. Because the system uses unlabeled queries without reference responses, the adaptation task tunes the LLM 110 to achieve grounding without heavily deviating from the original generations. In particular, the system adapts model 110 [symbol] to the adapted model 150 [symbol] so that the answers generated by the adapted LLM 150 [symbol] satisfy grounding constraints (with grounding score> [symbol] ) while maximizing the scores with respect to the base LLM [symbol] :

max [symbol] _{(·|Q,} [symbol] ₎ [symbol] (A|Q, [symbol] ) [symbol] { [symbol] (A, [symbol] )≥ [symbol] } (1)

In some implementations, a data-centric approach is used for optimizing the adapted LLM 150 [symbol] . In particular, the system uses a maximally grounded response sampled from the base LLM 110 to construct the tuning data.

To generate training data, the system samples responses {A} from the base LLM 110 [symbol] (·|Q, [symbol] ) using, for example, instruction following. In particular, for a given query, the base LLM 110 is presented with the query and n retrieved passages appended to an instruction that requires the base LLM 110 to answer the query based on the passages. These data are represented by block 152 in FIG. 1B.

After obtaining the initial response from the base LLM 110, the system breaks each response into sentences s₁, . . . , sₙ, as indicted by, e.g., sentences 130 and 132. For each sᵢ, the system determines a maximally supported passage eᵢ, e.g., passages 134 and 136, scored by the language model 120 ϕ(eᵢ, sᵢ).

A paring (citation of eᵢ to sᵢ) is created if ϕ(eᵢ, sᵢ) is greater than a first threshold score. Such pairings are illustrated by block 140. Conversely, for a sentence sᵢ for which each eᵢ is such that ϕ(eᵢ, sᵢ) is less than a second threshold, the sentence sᵢ is determined to be an unsupported statement and added to a set U, e.g., as illustrated by block 142. Collectively blocks 140 and 142 are represented by block 154 in FIG. 1B.

In some implementations, the first threshold is greater than the second threshold. More specifically, for each A=s₁, . . . , sₙ, the system creates citations [symbol] ={Eᵢ} using the model 120 to link a sentence sᵢ to the maximally supported passage eᵢ=ma [symbol] ϕ(d,sᵢ) if the passage eᵢ actually support sᵢ (i.e., ϕ(eᵢ,sᵢ)>τ) (as determined by the model 120). Otherwise, the system will not add a citation to sᵢ, and sᵢ is determined to be an unsupported statement, i.e., Eᵢ={eᵢ} if ϕ(eᵢ,sᵢ)>τ else {}. U denotes a set of unsupported statements for which citations are not determined to be found. Finally, the system choses a best response A* from {A} based on the grounding scores to form a grounded response, i.e., A*=arg max_{A} [symbol] (A,C). These data are collected into the training data 128, which includes tuples of queries, passages, and responses with citations.

The system then accomplishes tuning by using {Q, A*, C*} (C* as the citations associated with A*) to tune the base LLM 110 to generate grounded responses with citations. In addition to citations, the LLM 110 is also instructed to identify the unsupported statements U*. The based LLM 110 tuning results in the adapted LLM 150.

In some implementations, the tuning does not require all training responses to be grounded. Instead, supervised learning in used on the base LLM 110 to teach the base LLM 110 to identify unsupported statements.

In some implementations, to tune the LLM 110 into the adapted LLM 150, natural language formalization is used. The resulting verbalized natural language description is represented as VERB(A*, [symbol] *, U*). Verbalization, in some implementations, is done according to a template in an instruction following format, shown below in Table 1:

TABLE 1
Verbalization template for creating the training data for adapting the base LLM

```
    Input
  Task: You will be given a question and some search results. You are required to perform
  the following steps.
  First, please answer the question in 3-5 sentences, and make sure you mention relevant
  details in the search results. You may use the same words as the search results when
  appropriate. Note that some of the search results may not be relevant, so you are not
  required to use all the search results, but only relevant ones. If you use the provided search
  results in your answer, add [n]-style citations.
  Next, review your response and find the unsupported sentences that do not have citations.
  <Question> Search Results:
  [<Index>] <Title>
  <Text>
  [...]
    Output
Answer: <Response with citations>
  Sentences Not Supported by Citations: <Unsupported statements>
```

As shown in Table 1 above, the system verbalizes the citations in enclosed box brackets that are added at the end of sentences (before periods), e.g., [n], and verbalizes unsupported statements after the responses.

The base LLM 110 is then tuned using the language modelling objective:

$${ℳ}^{𝒜} = {arg max}_{ℳ} {\sum }_{Q} ℳ ( VERB ( {A}^{*} , {𝒞}^{*} , {U}^{*} ) \vert Q , 𝒟 ) \qquad ( 2 )$$

Equation 2 maximizes a log probability of generating the best-grounded answer A* that is selected from the generation output by the base LLM 110. As A* is sampled from the base LLM 110 outputs per the instructions, such an objective avoids significant deviations from the original generations, which aligns with the goal of the objective of Equation (1) above.

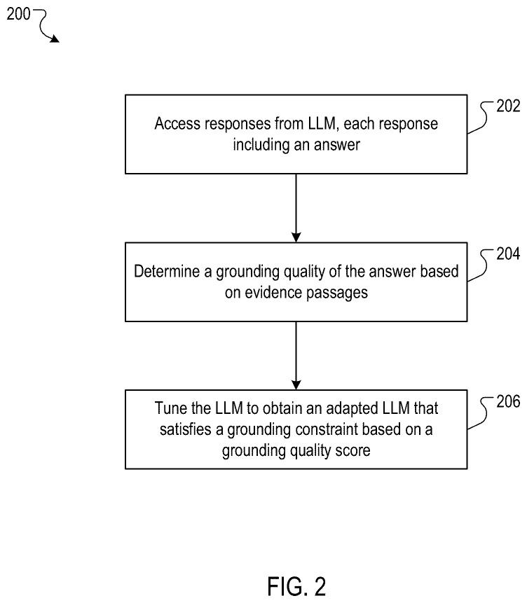

FIG. 2 is a flow diagram of an example process 200 for tuning an LLM into an adapted LLM. The process 200 can be implemented in a data processing apparatus of one or more computer devices that execute instructions that cause the data processing apparatus to perform the operations described.

The process 200 accesses responses from the LLM, each response including an answer (202). In some implementations, each of the responses includes a query, an answer to the query, where the answer is one or more statements, and citations linking each statement to an evidence passage in a corpus. For example, as shown in FIG. 1A, for the query 112, the responses 116, 118 from the base LLM 110 are accessed. The query and answer to the query may be determined by the base LLM 110, and the citations may be determined by another model, such as the model 120.

The process 200 determine a grounding quality of the answer based on evidence passages (204). For example, system breaks each response into sentences s₁, . . . , sₙ. Then, for each sᵢ, the system determines a maximally supported passage eᵢ as scored by the language model 120 ϕ(eᵢ, sᵢ). These are then collected into the training data 128.

The process 200 tunes the LLM 110 to obtain an adapted LLM 150 that satisfies a grounding constraint based on a grounding quality score (206). For example, the base LLM 110 is tuned to the adapted LLM 150 on the training data. In some implementations, a low-rank adaptation train process is used in which the process freezes the pre-trained base LLM model weights and injects trainable rank decomposition matrices into each layer of the transformer architecture. Other appropriate training techniques can also be used.

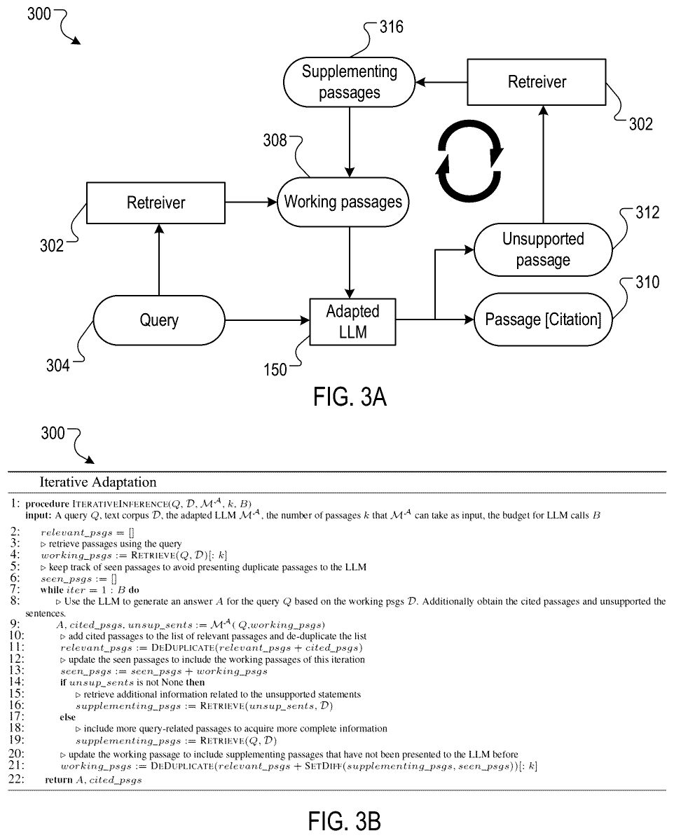

For the inference procedure, in some implementations an iterative adaptation method is used. One example adaptation procedure is illustrated in FIG. 3A, which is a system flow diagram of a retrieval augmented generation process 300 that the adapted LLM uses to self-ground its response to add citations to supported passages and identify unsupported passages.

The process 300 is performed in a retrieval augmented generation framework. The adapted LLM 150, as trained above, answers a query based on a set of given passages retrieved from a corpus and self-grounds the response to add citations to the passages as well as to find unsupported statements needing further investigation. In the framework of FIG. 3A, the adapted LLM iteratively constructs a set of relevant passages from the corpus [symbol] and refine its response to the query.

One example procedure of an iterative adaptation is illustrated in FIG. 3B, which is an illustration of an example inference procedure 350 performed in the system flow of FIG. 3A. Given a query 304, Q and a corpus [symbol] , the process 300 retrieves, from the corpus and based on the query 304, an initial set of working passages 308 using a retriever 302. In FIG. 3B, this is shown by lines 2-6. In some implementation, a large dual encoders model can be used as the retriever 302, such as a Generalizable T5-based dense Retriever (GTR). Other appropriate retrievers can also be used.

Next, the process 300 performs an iterative process until a cessation condition is met. The cessation condition can be an iteration count, a budget limit B that defines a budget of LLM calls, a time limit, an error limit, or any other appropriate constraint that can be used to cease an iterative process. In this example, a budget B is used, as indicated by line 7 in FIG. 3B.

At each iteration, the LLM 150 generates a response to the query based on the working passages, adds citations to its response, and identifies any unsupported statements that do not have citations. These data are output as 310 and 312, respectively.

To update the working passages 308, the process 300 determines whether there are unsupported statements. If so, the unsupported statements/passages 312 are processed by the retriever 302 to retrieve additional information based on the unsupported statements (as indicated by line 15 in FIG. 3B). If there are no unsupported sentences, and the budget B is not exhausted, the process 300 generates more passages that are retrieved by the retriever 302 based on the query to acquire additional information (as indicated by line 17 in FIG. 3B). The working passages 308 are then updated with the supplementing passages 316 that have not presented to the LLM 150 during a prior iteration (as indicated by lines 20-21 in FIG. 3B).

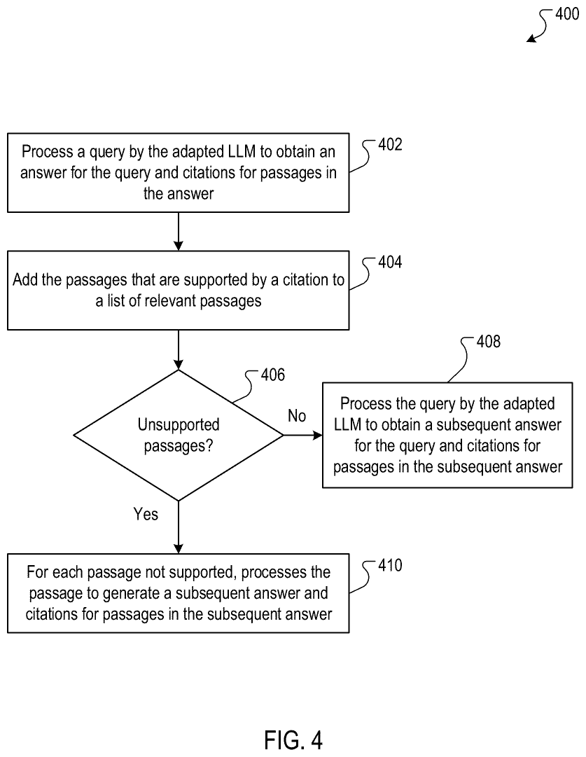

FIG. 4 is a flow diagram of an example process 400 of self-grounding the adapted LLM response to add citations to supported passages and identify unsupported passages. The process 400 can be implemented in a data processing apparatus of one or more computer devices that execute instructions that cause the data processing apparatus to perform the operations described.

The process 400 is an iterative process that continue to repeat until a cessation condition is met. The cessation condition can be an iteration count, a budget limit that defines a budget of LLM calls, a time limit, an error limit, or any other appropriate constraint that can be used to cease an iterative process.

The process 400 processes a query by the adapted LLM to obtain an answer for the query and citations for passages in the answer (402). For example, the adapted LLM 150 processes the query 304 and working passages 308 to obtain the answer that includes passages and citations.

The process 400 adds the passages that are supported by a citation to a list of relevant passages (406). For example, the adapted LLM 150 labels which passages are unsupported, and the supported passages are added to the list of relevant passages.

The process 400, for further processing, determines whether there are any unsupported passages (406). If the process 400 determines that there are no unsupported passages, then the process 400 processes the query by the adapted LLM to obtain a subsequent answer for the query and citations for passages in the subsequent answer (408).

Conversely, if the process 400 does determine there is one or more unsupported passage, then the process 400 processes each passage by an additional language model (e.g., by retriever 302) to generate a subsequent answer and citations for passages in the subsequent answer (412). Another iteration may then be performed and continues until the cessation event.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
accessing responses from a large language model, each response comprising data including:
a query;
an answer to the query, the answer comprising one or more statements; and
citations linking each statement to an evidence passage in a corpus;
determining a grounding quality of the answer based on the evidence passages and the statements using an attribution evaluation model, wherein the grounding quality is a quantification of attribution of the statements in the answer to a document corpus;
tuning the large language model to obtain an adapted large language model that satisfies a grounding constraint based on a grounding quality score.

2. The computer-implemented method of claim 1, further comprising:
iteratively processing a query by the adapted large language model, comprising:
initially processing the query by the adapted large language model to obtain an answer for the query and citations for passages in the answer;
for each subsequent iteration:
determining which passages in the answer are not supported by a citation;
adding the passages that are supported by a citation to a list of relevant passages;
if there are one or more passages in the answer that are not supported by a citation, then, for each passage not supported, processing the passage not supported to generate a subsequent answer and citations for passages in the subsequent answer;
otherwise processing the query by the adapted large language model to obtain a subsequent answer for the query based on the passages and citations for passages in the subsequent answer.

3. The computer-implemented method of claim 2, wherein iteratively processing the query by the adapted large language model to obtain an answer for the query and citations for passages in the answer comprises iteratively processing the query by the adapted large language model until an inference budget is exhausted.

4. The computer-implemented method of claim 2, wherein processing the passage not supported to generate a subsequent answer and citations for passages in the subsequent answer comprises processing the passage not supported by a retriever model to generate supplemental passages to be processed by the adapted large language model.

5. The computer-implemented method of claim 1, wherein determining a grounding quality of the answer based on the evidence passages and the statements using an attribution evaluation model comprises determining a sum of attribution evaluation model outputs, each output based on an evidence passage and statement provided as input to the attribution evaluation model.

6. The computer-implemented method of claim 1, wherein tuning the large language model to obtain an adapted large language model that satisfies a grounding constraint based on grounding quality score further comprises tuning the large language model so that answers generated by the adapted large language model maximizing scores with the respect to the large language model such that:
max [symbol] _{(·|Q,} [symbol] ₎ [symbol] (A|Q, [symbol] ) [symbol] { [symbol] (A, [symbol] )≥ [symbol] }.

7. A system comprising one or more computers and one or more storage devices storing instructions that are operable, when executed by the one or more computers, to cause the one or more computers to perform the operations of:
accessing responses from a large language model, each response comprising data including:
a query;
an answer to the query, the answer comprising one or more statements; and
citations linking each statement to an evidence passage in a corpus;
determining a grounding quality of the answer based on the evidence passages and the statements using an attribution evaluation model, wherein the grounding quality is a quantification of attribution of the statements in the answer to a document corpus;
tuning the large language model to obtain an adapted large language model that satisfies a grounding constraint based on a grounding quality score.

8. The system of claim 7, the operations further comprising:
iteratively processing a query by the adapted large language model, comprising:
initially processing the query by the adapted large language model to obtain an answer for the query and citations for passages in the answer;
for each subsequent iteration:
determining which passages in the answer are not supported by a citation;
adding the passages that are supported by a citation to a list of relevant passages;
if there are one or more passages in the answer that are not supported by a citation, then, for each passage not supported, processing the passage not supported to generate a subsequent answer and citations for passages in the subsequent answer;
otherwise processing the query by the adapted large language model to obtain a subsequent answer for the query based on the passages and citations for passages in the subsequent answer.

9. The system of claim 8, wherein iteratively processing the query by the adapted large language model to obtain an answer for the query and citations for passages in the answer comprises iteratively processing the query by the adapted large language model until an inference budget is exhausted.

10. The system of claim 8, wherein processing the passage not supported to generate a subsequent answer and citations for passages in the subsequent answer comprises processing the passage not supported by a retriever model to generate supplemental passages to be processed by the adapted large language model.

11. The system of claim 7, wherein determining a grounding quality of the answer based on the evidence passages and the statements using an attribution evaluation model comprises determining a sum of attribution evaluation model outputs, each output based on an evidence passage and statement provided as input to the attribution evaluation model.

12. The system of claim 7, wherein tuning the large language model to obtain an adapted large language model that satisfies a grounding constraint based on grounding quality score further comprises tuning the large language model so that answers generated by the adapted large language model maximizing scores with the respect to the large language model such that:
max [symbol] _{(·|Q,} [symbol] ₎ [symbol] (A|Q, [symbol] ) [symbol] { [symbol] (A, [symbol] )≥ [symbol] }.

13. A computer storage medium encoded with instructions that, when executed by one or more computers, cause the one or more computers to perform operations comprising:
accessing responses from a large language model, each response comprising data including:
a query;
an answer to the query, the answer comprising one or more statements; and
citations linking each statement to an evidence passage in a corpus;
determining a grounding quality of the answer based on the evidence passages and the statements using an attribution evaluation model, wherein the grounding quality is a quantification of attribution of the statements in the answer to a document corpus;
tuning the large language model to obtain an adapted large language model that satisfies a grounding constraint based on a grounding quality score.

14. The computer storage medium of claim 13, the operations further comprising:
iteratively processing a query by the adapted large language model, comprising:
initially processing the query by the adapted large language model to obtain an answer for the query and citations for passages in the answer;
for each subsequent iteration:
determining which passages in the answer are not supported by a citation;
adding the passages that are supported by a citation to a list of relevant passages;
if there are one or more passages in the answer that are not supported by a citation, then, for each passage not supported, processing the passage not supported to generate a subsequent answer and citations for passages in the subsequent answer;
otherwise processing the query by the adapted large language model to obtain a subsequent answer for the query based on the passages and citations for passages in the subsequent answer.

15. The computer storage medium of claim 14, wherein iteratively processing the query by the adapted large language model to obtain an answer for the query and citations for passages in the answer comprises iteratively processing the query by the adapted large language model until an inference budget is exhausted.

16. The computer storage medium of claim 14, wherein processing the passage not supported to generate a subsequent answer and citations for passages in the subsequent answer comprises processing the passage not supported by a retriever model to generate supplemental passages to be processed by the adapted large language model.

17. The computer storage medium of claim 13, wherein determining a grounding quality of the answer based on the evidence passages and the statements using an attribution evaluation model comprises determining a sum of attribution evaluation model outputs, each output based on an evidence passage and statement provided as input to the attribution evaluation model.

18. The computer storage medium of claim 13, wherein tuning the large language model to obtain an adapted large language model that satisfies a grounding constraint based on grounding quality score further comprises tuning the large language model so that answers generated by the adapted large language model maximizing scores with the respect to the large language model such that:
max [symbol] _{(·|Q,} [symbol] ₎ [symbol] (A|Q, [symbol] ) [symbol] { [symbol] (A, [symbol] )≥ [symbol] }.
